SEQUENCE LISTING (26 sequences)

SEQ ID NO: 1 - DNA, 22 bp, Artificial
  Synthetic oligonucleotide
ctacgtggcctttgtcaccgac

SEQ ID NO: 2 - DNA, 22 bp, Artificial
  Synthetic oligonucleotide
ggtagaggcggcgatggttgaa

SEQ ID NO: 3 - DNA, 34 bp, Artificial
  Synthetic oligonucleotide
ttcaatatctttgtacaagaaggcgtactcgacc

SEQ ID NO: 4 - DNA, 34 bp, Artificial
  Synthetic oligonucleotide
atgttgttgacttaacaagaaggcgtactcgacc

SEQ ID NO: 5 - DNA, 34 bp, Artificial
  Synthetic oligonucleotide
ctttgtgtataggaacaagaaggcgtactcgacc

SEQ ID NO: 6 - DNA, 34 bp, Artificial
  Synthetic oligonucleotide
agggcagtaaagtaacaagaaggcgtactcgacc

SEQ ID NO: 7 - DNA, 35 bp, Artificial
  Synthetic oligonucleotide
ttataaggatttcttacaagaaggcgtactcgacc

SEQ ID NO: 8 - DNA, 14 bp, Artificial
  Synthetic oligonucleotide
acaaagatattgaa

SEQ ID NO: 9 - DNA, 14 bp, Artificial
  Synthetic oligonucleotide
taagtcaacaacat

SEQ ID NO: 10 - DNA, 14 bp, Artificial
  Synthetic oligonucleotide
tcctatacacaaag

SEQ ID NO: 11 - DNA, 14 bp, Artificial
  Synthetic oligonucleotide
tactttactgccct

SEQ ID NO: 12 - DNA, 15 bp, Artificial
  Synthetic oligonucleotide
aagaaatccttataa

SEQ ID NO: 13 - DNA, 20 bp, Artificial
  Synthetic oligonucleotide
cgtccmarrggawactgatc

SEQ ID NO: 14 - DNA, 20 bp, Artificial
  Synthetic oligonucleotide
gcmcagggwcataayaatgg

SEQ ID NO: 15 - DNA, 45 bp, Artificial
  Synthetic oligonucleotide
gctagatgaagagcaagcgcatggaacgcagtacaaatatgtcat

SEQ ID NO: 16 - DNA, 45 bp, Artificial
  Synthetic oligonucleotide
tacaaccgacagatgtatgtaaggcacgcagtacaaatatgtcat

SEQ ID NO: 17 - DNA, 45 bp, Artificial
  Synthetic oligonucleotide
ttcaatctggtctgacctccttgtgacgcagtacaaatatgtcat

SEQ ID NO: 18 - DNA, 45 bp, Artificial
  Synthetic oligonucleotide
acacgatgtgaatattatctgtggctcgcagtaccaatttaacaa

SEQ ID NO: 19 - DNA, 45 bp, Artificial
  Synthetic oligonucleotide
ttgaagttcgcagaatcgtatgtgttcgcagtaccaatttaacaa

SEQ ID NO: 20 - DNA, 45 bp, Artificial
  Synthetic oligonucleotide
aacgtctgttgagcacatcctgtaatcgcagtaccaatttaacaa

SEQ ID NO: 21 - DNA, 25 bp, Artificial
  Synthetic oligonucleotide
tccatgcgcttgctcttcatctagc

SEQ ID NO: 22 - DNA, 25 bp, Artificial
  Synthetic oligonucleotide
gccttacatacatctgtcggttgta

SEQ ID NO: 23 - DNA, 25 bp, Artificial
  Synthetic oligonucleotide
cacaaggaggtcagaccagattgaa

SEQ ID NO: 24 - DNA, 25 bp, Artificial
  Synthetic oligonucleotide
gccacagataatattcacatcgtgt

SEQ ID NO: 25 - DNA, 25 bp, Artificial
  Synthetic oligonucleotide
acacatacgattctgcgaacttcaa

SEQ ID NO: 26 - DNA, 25 bp, Artificial
  Synthetic oligonucleotide
ttacaggatgtgctcaacagacgtt

(19) United States
(12) Patent Application Publication
(10) Pub. No.: US 2011/0065589 A1
(43) Pub. Date: Mar. 17, 2011

(54) Devices and Methods of Anonymously Deconvoluting Combined Patient Samples And Combined Patient Assays

(76) Inventor: Nanibhushan Dattagupta, San Diego, CA (US)

(21) Appl. No.: 12/518,006

(22) PCT Filed: Dec. 13, 2007
(86) PCT No.: PCT/US07/25647

§ 371 Date: Oct. 27, 2010

Related U.S. Application Data
(60) Provisional application No. 60/869,850, filed on Dec. 13, 2006.

(51) Int. Cl. C40B 20/06; C40B 60/10

(52) U.S. Cl. 506/5; 506/38

(57) ABSTRACT

Individual patient- and disease-specific test results are obtained from a mixture of one or more distinct tests from multiple combined and distinct patient samples or reactions. In an especially preferred aspect, multiple reaction products from oligonucleotides having unique identifier portions are prepared or received from a clinician and combined for hybridization on a chip. Test results are deconvoluted using a deconvolution table in which associative data are employed to provide access to the individual patient- and disease-specific test results.

This application claims priority to our copending U.S. provisional patent application with the Ser. No. 60/869,850, which was filed Dec. 13, 2006.

### FIELD OF THE INVENTION

Multiplexed genetic test methods, compositions, and devices, and especially as they relate to those where combined multiple and distinct tests from combined multiple and distinct patient samples or reactions are analyzed on a single chip.

### BACKGROUND OF THE INVENTION

Most multiplexed genetic tests are typically performed in a manner that addresses a plurality of aspects of a single condition such that a plurality of reaction products are analyzed together on a single analytic platform. For example, numerous multiplex tests are known for the diagnosis of HPV genotypes from a single patient sample. Here, one patient sample is reacted in a multiplex PCR to produce a plurality of products that are then applied to a single chip for hybridization of individual reaction products at predetermined positions. So obtained hybridization patterns are then indicative of viral infection with one or more viral genotypes.

While such multiplex assays are relatively simple and provide multiple test results from a single PCR reaction, several disadvantages remain. Among other things, chips in such assays are limited to single patient samples. Similarly, the chips in such assays are generally used for only one type of condition tested (e.g., HPV typing or SNP analysis). Consequently, despite the potential of having several hundred, thousand, or even ten thousand analytes tested on a single chip, currently known diagnostic chip-based tests for examination of a health condition utilize only a minute fraction of that potential.

In other uses of known multiplex assays, high densities of capture probes for analytes are commonly found in chips or other solid-phase platforms where the analytes are grouped by certain criteria. For example, there are numerous chips and arrays for gene expression profiling focusing on cancer, inflammation, immunity, etc. While such solid phase arrays offer the possibility to screen very large populations of genes at the same time, hybridization conditions and capture probe sequences must be carefully chosen to obtain a somewhat accurate result. As a consequence, allele specific analysis is typically not possible using such arrays, and cross-hybridization is frequently encountered.

Therefore, while numerous devices and methods of multiplexed solid phase genomic analyses are known in the art, all or almost all of them suffer from various disadvantages. Consequently, there is still a need to provide improved devices and methods to accelerate and simplify multiplexed solid phase genomic analyses.

### SUMMARY OF THE INVENTION

The present invention is directed to methods and devices for multiplexed analysis in which individual, patient- and test-specific test results are obtained from a complex mixture of multiple and distinct patient tests from multiple and distinct patients. Most preferably, the methods and devices contemplated herein employ oligonucleotides with multiple specific portions to produce a plurality of labeled products, which are then hybridized onto a solid phase. Signals from the mixture are then deconvoluted using a deconvolution table to obtain the individual, patient- and test-specific test results.

In one aspect of the inventive subject matter, a method of assisting or facilitating the execution of a multiplexed diagnostic assay includes one step of providing a plurality of oligonucleotides, wherein (a) a first population of the plurality of oligonucleotides have a common first portion that is specific for a first diagnostic marker, (b) a second population of the plurality of oligonucleotides have a common first portion that is specific for a second diagnostic marker, (c) wherein each of the plurality of oligonucleotides have a distinct second portion, and wherein each of the plurality of oligonucleotides has a unique identifier associated with the distinct second portion. In another step, instructions are provided to separately prepare a plurality of labeled nucleic acids from each of a plurality of different patient samples using at least one oligonucleotide of the first and second populations, and in a still further step, instructions are provided to pool the pluralities of labeled nucleic acids from the different patient samples and to hybridize the pluralities of labeled nucleic acids to oligonucleotides immobilized to a solid phase. In yet another step, a deconvolution table is provided that associates a single test result for each of the different patients based on the first and second diagnostic markers using the unique identifier.

While in preferred aspects the solid phase has a chip in which the oligonucleotides are immobilized in a predetermined pattern, the solid phase in other embodiments may comprise a plurality of color-coded beads, wherein beads of same color carry the same nucleotide sequences. Most typically, the first portions in the first and second populations have a length of between 12 and 40 nucleotides, respectively, and the distinct second portions have a length of between 6 and 20 nucleotides. It is further preferred that the unique identifier comprises a numerical sequence, alphanumerical sequence, an/or a mixed numerical/alphanumerical sequence, and optionally includes a reference to the particular test.

While numerous reactions may be suitable for use in conjunction with the teachings presented herein, it is typically preferred that the labeled nucleic acids are prepared by PCR and/or (allele specific) primer extension. Therefore, the label may vary considerably and may indeed include all optically detectable labels, including fluorophors, dyes, and luminophors. Similarly, the nature of the test may vary considerably, and all known nucleic acid based tests are deemed suitable for use herein so long as such test can be performed with nucleic acids as presented herein. However, particularly preferred tests include those for an oncogene, a mutation in a SNP, presence of a viral or bacterial nucleic acid, and a virotype.

It is further preferred that the deconvolution table comprises an electronic database and is provided as an on-line software upload or on a data carrier, and may also be configured to allow cooperation with a reader of an analytic device and an output module of the analytic device such that the test result is calculated using a readout of the reader and such that the test result is provided to the output module.

In another aspect of the inventive subject matter, a data storage medium and software are contemplated that include (a) associative data of a plurality of diagnostic marker-specific first portions of a plurality of oligonucleotides, respectively, with a plurality of distinct second portions present in each of the plurality of oligonucleotides; (b) associative data of the distinct second portions of the plurality of oligonucleotides with a solid phase parameter; and (c) associative data of each of the plurality of oligonucleotides with a patient identifier such that the table correlates a plurality of diagnostic tests for at least two distinct patients. Most preferably, the associative data (a) and (b) are preprogrammed and the software is further programmed to acquire the patient identifier from an operator, an analytic device, and/or an electronic device coupled to the analytic device to thereby generate associative data (c).

Most preferably, the software is further programmed to receive test results for each of the plurality of diagnostic tests to thereby establish a test result for the at least two distinct patients. For example, the software may be configured to allow cooperation with a reader of an analytic device and an output module of the analytic device such that a test result is calculated using a readout of the reader and such that the test result is provided to the output module. Depending on the type of solid phase (e.g., array chip), it is contemplated that suitable solid phase parameters may comprise location identification of at least one of the plurality of oligonucleotides on the array chip. In further preferred aspects, the plurality of diagnostic marker-specific first portions are associated with a single condition (e.g., infection, neoplasm, genetic predisposition, etc.)

### DETAILED DESCRIPTION

The inventors have now discovered that multiple patient samples can be processed on a single chip in a manner that allows for rapid and sensitive detection of multiple analytes on a single chip such that the chip need not be customized for a specific test, and such that two or more patient samples from distinct tests can be combined prior to application to the chip. In especially contemplated tests and methods, individual test results are then determined using a deconvolution table.

It should be particularly appreciated that using compositions and methods according to the inventive subject matter, an array chip can be utilized to full capacity regardless of the type of the test and number of patients. Most advantageously, array chips will be supplied with suitable sets of oligonucleotides for multiple diagnostic tests and a deconvolution table. In especially preferred aspects, the deconvolution table is provided as downloadable software or on a data carrier. Additionally, it is preferred that the array chip and oligonucleotides are configured to allow for nucleic acid analysis (e.g., SNP analysis, allele specific analysis, and other genetic analyses) without cross-hybridization, wherein the system uses a deconvolution table to assign a specific test result from the solid phase to an individual patient. Thus, it should be recognized that contemplated systems and methods increase the volume of tests performed on a single chip from multiple tests for a single patient or single tests for multiple patients in a test-type specific manner to a format in which multiple and distinct tests can be performed for multiple and distinct patients in a test-type independent manner.

In one particularly preferred aspect of the inventive subject matter and with respect to contemplated oligonucleotides, each test will include a plurality of oligonucleotides, wherein (a) a first population of the plurality of oligonucleotides have a common first portion that is specific for a first diagnostic marker (e.g., viral genotype, SNP in an allele, mutation in an oncogene, etc.), (b) a second population of the plurality of oligonucleotides have a common first portion that is specific for a second diagnostic marker (e.g., different viral genotype, different SNP in an allele, different mutation in an oncogene, etc.), and (c) wherein each of the plurality of oligonucleotides have a distinct second portion, respectively. Most typically, each of the plurality of oligonucleotides has a unique identifier (e.g., sequence information, identification number or code, patient name, etc.) associated with the distinct second portion. Therefore, a typical oligonucleotide of the first and second population will have the general structure (I)

5′-(X)ₙ₁-(Z)-(X)ₙ₂-(Y)-(P)-3′ (I)

wherein X is a nucleotide (A, G, C, or T, or nucleotide analog), Y is the common first portion (e.g., to hybridize with one strand of an amplicon), n₁ and n₂ are independently an integer between 0 and 50, Z is the distinct second portion (effective to hybridize selectively to one capture nucleotide of the solid phase), and P is the 3′-terminal nucleotide of the first portion. Z and Y are typically unbranched oligonucleotide sequences or analogs thereof, and may have any length so long as such length will allow hybridization to a complementary portion under predefined hybridization conditions. Thus, and most typically Z and Y will have a length of between 8 and 50 nucleotides, and more typically between 12 and 30 nucleotides (e.g., Z between 12-40 nucleotides and Y between 6 and 20 nucleotides). Most preferably, and particularly where the oligonucleotide has a length of more than 30 bases (or more than 40 bases), the oligonucleotides of structure (I) are purified to homogeneity (e.g., gel purified or HPLC purified) such that at least 90 mol %, more typically at least 92 mol %, and most typically at least 95 mol % of an oligonucleotide preparation has the same number of bases.

In further particularly preferred aspects, it is contemplated that the sequences of Z and Y are selected such that Z of a first oligonucleotide will not hybridize throughout at least 85%, more typically at least 90%, and most preferably at least 99% of the entire length under stringent hybridization conditions (wash with 6×SSC) to (1) a capture sequence complementary to Z of a second oligonucleotide, (2) Y of the same oligonucleotide, and (3) Y of the second or a third oligonucleotide. Thus, washing of an array (or other solid phase composition) under stringent conditions will produce specific signals.

Of course, it should be recognized that the oligonucleotides may be provided in any format, however, it is generally preferred that the oligonucleotides are provided in either a sample container in which the patient sample is collected (e.g., VACUTAINER™ [BDI, Inc.]), in individual vials, or in a multiwell plate suitable for automated transfer to a downstream PCR reaction or primer extension reaction. Regardless of the manner of transfer, however, each of the oligonucleotides will be associated with a unique identifier, and such association may be done in numerous manners.

Most typically, association is achieved by at least two, and in many cases three or even more associative data. For example, where the oligonucleotide is present in a particular well of a multiwell plate, the first associative data may comprise a unique ID number, and/or at least part of the sequence of the second portion. Alternatively, the first associative data may also be present in form of a label with printed information comprising a unique ID number and/or at least part of the sequence of the second portion, especially where the oligonucleotide is provided in a tube. Similarly, where the oligonucleotide is provided on a colored bead, the first associative data may include spectral information of the bead, a unique ID number, and/or at least part of the sequence of the second portion. Solid phase parameters other than tube, multiwell, or bead color may include expected Rf value in electrophoretic assays, expected impact position in mass-spectroscopy assays (correlating to predicted molecular weight). Additionally, but not necessarily, the first associative data may also include information regarding the first portion (e.g., at least partial sequence information, type of test to be performed, etc.). Thus, it should be appreciated that the first associative data will enable a user to unambiguously identify a specific oligonucleotide, and typically also the expected location on/type of solid phase to which the oligonucleotide is bound after hybridization using the second portion.

Second associative data preferably include information that correlate the first portion with one unique second portion and/or with positional information on a solid phase with respect to hybridization of the oligonucleotide using the unique second portion. Alternatively, the second associative data may also provide information on use or sequence of the first portion of a specific oligonucleotide with regard to the vessel in which it is delivered. First portion information is preferably at least one of an information on intended use, test type, reference to a pre-installed test protocol on an automated analyzer, and/or at least partial sequence information of the first portion. Thus, such information will provide information to a user on a particular use for the specific oligonucleotide due to the oligonucleotide's first portion. Additionally, it should be recognized that the second associative data may further include information on other oligonucleotides, preferably within the same group of diagnostic tests. As a result, second associative information may not only be used to provide information to a user on a particular use, but also be used to group results, align, and/or group a plurality of oligonucleotides on a solid phase.

With respect to contemplated third associative data it should be recognized that all associative information is deemed suitable that links an anonymous or specific patient identification with a specific oligonucleotide. Preferably, the third associative data associates information about the distinct second portion (and further optional sequence information, including sequence of the first portion, type of test in which the oligonucleotide is used, etc.) with information specific to the patient. For example, where patient specific anonymous information is employed, such patient ID may be a numerical and/or alphanumerical code sequence, a barcode, an RFID tag signal. On the other hand, and more typically, the patient specific information may include the name of the patient, social security number, the name of the prescribing physician or medical group, etc. Alternatively or additionally, the third associative data may further include associative data include third-party information to which test results and other information can be provided (e.g., to physician or practice group). In less preferred aspects, the third associative data may also comprise information regarding the type of test and/or sequence information of the first and/or second portions. However, and regardless of the specific format and content, it should be recognized that the third associative data will provide a link between the patient sample and the specific oligonucleotide used (optionally in a specific test).

Most typically first and second associative data are preprogrammed or provided in an otherwise preset format to the deconvolution table to avoid operator error. Alternatively, or additionally, where data are not preprogrammed or in electronically readable or transferable format, associative data may be manually entered or provided in a format such that the operating system of an automated analyzer can acquire such data (preferably, but not necessarily) without manual user intervention. For example, associative data may be provided to the automated analyzer by barcode, radiofrequency identification tag, etc. Thus, first, second, and/or third associative data may be provided as numerical sequence, alphanumerical sequence, and mixed numerical/alphanumerical sequence, bar code, etc. in printed and/or electronic format.

Preferably, the third associative data is generated at the point of execution of the test and it is generally preferred that the patient identifier is acquired by the analytic system (or computer or network coupled to the analytic system). For example, third associative data may be entered by an operator, the analytic device, and/or an electronic device (barcode reader, scanner, OCR video system, voice input, etc.) coupled to the analytic device to thereby generate the third associative data. Alternatively, the third associative data may be embedded in the first and/or second associative data. In further contemplated aspects, the third associative data may also be provided by way of the patient sample that is shipped to the location where the automated analyzer is operating.

Thus, it should be recognized that all associative data may be provided collectively, individually, in printed, displayed, and/or electronic format, which may be stored in a file or part of a file (e.g., executable or database), on a data carrier (e.g., CD), in downloadable format, and so on. Depending on the data carrier (and reader), the associative data can be encoded in machine or operator readable text or depiction, etc. Most typically, the first and second associative data are provided by the supplier of the chip array and/or oligonucleotides.

In further especially contemplated aspects, the deconvolution table is configured to allow cooperation with a processor, a reader of an analytic device, and an output module of the analytic device such that a test result for a particular test and a particular patient is calculated using a readout of the reader for a particular hybridization event, and such that the test result is provided to the output module. For example, the deconvolution table may provide information on the location of a specific oligonucleotide on a chip, and the reader of the analytic device acquires a signal from that location. Further using data of the deconvolution table, the processor will then calculate a test-specific test result from the signal (e.g., advise of presence of a specific viral sequence based on the signal and the common first portion). In another step, and still based on the deconvolution table (here: third associative data), the processor will assign the test result to the patient ID and provide output to the output module for the specific test result for that patient. Typical output modules include screens, printers, electronic data transfer devices (e.g., wireless network, LAN, etc.) and/or electronic data storage devices (hard disk, SDRAM, etc.), and the output may therefore be directly readable by the operator or person ordering the test. Consequently, the output format of the output module may be a display on a screen, an electronic file, a fax, an email, and/or a printout.

While in some aspects of the inventive subject matter the deconvolution table may be complete prior to uploading into the analytic device, the table is more typically partial prior to uploading in other aspects. In such case, the remaining portion of the table is (preferably automatically) acquired from the operating system of the analytic device, an operator or other source to provide the third associative data. Thus, deconvolution tables may be in printed format, electronic format, or any combination thereof.

In one exemplary method, oligonucleotides are provided wherein a first population of the oligonucleotides have a common first portion that is specific for a first diagnostic marker, wherein a second population of the oligonucleotides have a common first portion that is specific for a second diagnostic marker, wherein each of the oligonucleotides have a distinct second portion, and wherein each of the plurality of oligonucleotides has a unique identifier associated with the distinct second portion. Instructions are then provided to separately prepare a plurality of labeled nucleic acids from each of a plurality of different patient samples using at least one oligonucleotide of the first and second populations, and further instructions are provided to pool the pluralities of labeled nucleic acids from the different patient samples and to hybridize the pluralities of labeled nucleic acids to oligonucleotides immobilized to a solid phase. In yet a further step, a deconvolution table is provided that associates a single test result for each of the different patients based on the first and second diagnostic markers using the unique identifier.

Once multiple patient samples have been collected, a plurality of labeled nucleic acids are prepared from each of a plurality of different patient samples using at least one oligonucleotide of the first and second populations. Suitable labeling reactions include all known reactions, however, it is especially preferred that the labeled nucleic acids are prepared in a primer extension reaction from an amplicon that was previously prepared from the patient sample. Therefore, additional oligonucleotide pairs are contemplated that will amplify a gene or portion thereof that is associated with the condition to be examined. Alternatively, the labeled nucleic acids may also be directly prepared in a PCR using fluorescent labels to thereby produce labeled amplicons. In yet further alternative aspects, the oligonucleotide of structure (I) may already include a label (e.g., radio isotope label, fluorescent, luminescent, or phosphorescent label).

After the labeled nucleic acids are prepared, the pluralities of labeled nucleic acids from the different patient samples and even different types of tests are pooled and hybridized to capture oligonucleotides immobilized to a solid phase. Most preferably, the solid phase is a chip or other array of oligonucleotides, or is a plurality of color coded beads, each carrying a single species of capture nucleotides. The capture nucleotides have a sequence that is complementary to a second portion of a labeled nucleotide. Thus, by providing physically separate and individually addressable locations for distinct capture nucleotides, each of the first and second labeled oligonucleotides can be detected and quantified via the unique second portion in the labeled oligonucleotide. As each of the second portions has a further identifier, typically linked to a patient and/or test ID, multiple and distinct tests and multiple and distinct patient samples can be processed on a single chip.

With respect to the purity of the capture nucleotides, it is preferred that the capture nucleotides are purified to homogeneity (e.g., gel purified or HPLC purified) such that at least 90 mol %, more typically at least 92 mol %, and most typically at least 95 mol % of an oligonucleotide preparation has the same number of bases. Especially suitable solid phases include those in which the capture oligonucleotides are immobilized in a predetermined pattern (e.g., to a glass or plastic plate, or to a gel matrix). Typically, at least 10, more typically at least 50, even more typically at least 100, and most typically at least 200 capture nucleotides will be immobilized on a solid phase. Moreover, due to the high specificity and homogenous preparation of the oligonucleotides (capture and/or labeled oligonucleotide), the hybridization reaction can be carried out at a single temperature (and less typically at two different temperatures) for all of the oligonucleotides applied to the array or mixture of beads, with three or less wash steps required to obtain analyte specific signals with low background signals.

Identification of test results and assignment of the results to the appropriate patient is then performed using data from the deconvolution table (e.g., as electronic database, or printed or displayed information). Thus, a single test result for each of the different patients is determined on the basis of a measured outcome (e.g., fluorescence, luminescence associated with type of or position on solid phase) based on the first and second diagnostic markers and using the unique identifier.

Preferably, a data storage medium includes software that is programmed to establish a deconvolution table that comprises (a) associative data of a plurality of diagnostic marker-specific first portions of a plurality of oligonucleotides, respectively, with a plurality of distinct second portions present in each of the plurality of oligonucleotides (e.g., data identifying the sequence information and/or test type of the first portion with an individual oligo identifier and/or patient code), (b) associative data of the distinct second portions of the plurality of oligonucleotides with a solid phase characteristic (e.g., data identifying expected hybridization location of a specific oligo to the solid phase), and (c) associative data of each of the plurality of oligonucleotides with a patient identifier such that the table correlates a plurality of diagnostic tests for at least two distinct patients, wherein the associative data (a) and (b) are preprogrammed, and wherein the software is further programmed to acquire the patient identifier from an operator (e.g., manual or scanner input) or operating system (e.g., via barcode or RFID) to thereby generate associative data (c). Where desirable, the software may also be programmed to automatically receive test results for each of the plurality of diagnostic tests to thereby establish a test result for the at least two distinct patients.

### EXAMPLES

### Multiple Simulated Patient Samples Assayed Simultaneously for the Detection of Mycobacterium sp. BCG on a Single Microarray

Mycobacterium genomic DNA (ATCC 19015D-5, Mycobacterium sp. BCG) was purchased from ATCC. Four different samples (1 ng/10 microliter of water) and water were taken in five separate PCR tubes. They were amplified after adding 10 microliter of PCR master mix (200 micromolar dNTPs, 2 mM magnesium chloride, 0.5 microliter Titanium Taq polymerase) and PCR primers 10 picomoles each of AGT01060A and AGT 01059 and thermocycling 30 cycles at 95° C. (20 seconds), 54° C. (30 seconds) and 72° C. (30 seconds). To the PCR product detection primer extension reagent (20 microliter) was added, which contained the mycobacterium specific probe with a sample recognition specific sequence and cy5 dye labeled dCTP in trisHCl buffer. Without adding any more enzyme, two temperature thermocycling at 95 and 54° C. was continued for 40 cycles.

20 microliter of the products from each PCR tube were mixed and 10 microliter of 10 mM EDTA was added to stop the reaction. The final mixture of 110 microliter was added onto a BIOFILM CHIP microarray (AUTOGENOMICS, Carlsbad, Calif.) for hybridization with capture probes complementary to the capture probe-specific recognition sequences, which were pre-immobilized at predetermined positions onto the chip. After capture hybridization for 60 minutes, the chips were washed with 6×SSC ten times on the system and scanned. The experiments were repeated by changing and recombining different recognition sequences for different samples. When analyzed in an automated analyzer (Infinity System, AUTOGENOMICS, Carlsbad, Calif.), each of the samples applied to the microarray hybridized in the predetermined position carrying a complementary capture probe.

A printed deconvolution table included the entire sequences for each of the different primers for the linear extension and made specific reference to the oligo-specific recognition sequence (in lower case in the table below) and test specific sequence (in upper case in the table below). The table made further reference to specific oligonucleotide ID (here: names for DPE primers, based on the oligo-specific recognition sequence), which was associated with a specific test sample number simulating a patient ID number. Finally, the table also included positional information with respect to expected binding of the respective labeled extension products on the solid phase (e.g., position on an array of capture nucleotides or spectral ID of a colored bead). These results clearly indicated that test results for distinct samples can be identified based on signal location and associative data to yield specific results.

Primers for amplification of a target sequence in the Mycobacterium were as follows (depicted as 5′ - - - 3′ sequence):

| | |
|---|---|
| Forward AGT01060A | |
| CTACGTGGCCTTTGTCACCGAC | SEQ ID 1 |
| Reverse AGT01059 | |
| GGTAGAGGCGGCGATGGTTGAA | SEQ ID 2 |

Primers for linear extension of the amplified sequences of Mycobacterium were as follows (depicted as 5′ - - - 3′ sequence):

| DPE Primers | Sequence 5′ - - - 3′ | |
|---|---|---|
| T027-6110 | ttcaatatctttgtACAAGAAGGCGTACTCGACC | SEQ ID 3 |
| T038-6110 | atgttgttgacttaACAAGAAGGCGTACTCGACC | SEQ ID 4 |
| T039-6110 | ctttgtgtataggaACAAGAAGGCGTACTCGACC | SEQ ID 5 |
| T060-6110 | agggcagtaaagtaACAAGAAGGCGTACTCGACC | SEQ ID 6 |
| T061-6110 | ttataaggatttcttACAAGAAGGCGTACTCGACC | SEQ ID 7 |

Capture probe-specific recognition sequences are in lower case.

Primers for hybridization of extended and labeled sequences of Mycobacterium were as follows (depicted as 5′ - - - 3′ sequence; all biotinylated at 3′-end):

| Capture | | |
|---|---|---|
| Primers | Sequence 5′ - - - 3′Bio | |
| Cp027 | ACAAAGATATTGAA | SEQ ID 8 |
| Cp038 | TAAGTCAACAACAT | SEQ ID 9 |
| Cp039 | TCCTATACACAAAG | SEQ ID 10 |
| Cp060 | TACTTTACTGCCCT | SEQ ID 11 |
| Cp061 | AAGAAATCCTTATAA | SEQ ID 12 |

### Multiple Samples Assayed Simultaneously for the Detection of Human Papillomavirus Types 16 and 18

Plasmid DNA containing cloned sequences of human papillomavirus types 16 and 18 were purchased from Maxim Biotech, Inc. (Rockville, Md.). Three different samples (1 ng/10 microliter of water) were taken in three separate PCR tubes, which simulated three different patient samples. They were independently amplified after adding 10 microliter of PCR master mix (200 micromolar dNTPs, 2 mM magnesium chloride, 0.5 microliter Platinum Taq polymerase) and PCR primers 10 picomoles of MY09 and MY11 and thermocycling 40 cycles at 95° C. (1 minute), 55° C. (1 minute) and 72° C. (1 minute). To the PCR product detection primer extension reagent (20 microliter) was added, which contained specific probes for HPV types 16 and 18 with sample recognition sequences and cy5 dye labeled dCTP in Tris-HCl buffer. Without adding any more enzyme two temperature, thermocycling at 95 and 54° C. was continued for 40 cycles.

20 microliter of the products from each PCR tubes are mixed and 10 microliter of 10 mM EDTA was added to stop the reaction. Then 40 microliter of hybridization buffer was added and the final mixture of 110 microliter was added onto a BIOFILM CHIP microarray (AUTOGENOMICS, Carlsbad, Calif.) for hybridization with capture probes complementary to the capture probe-specific recognition sequences, which were immobilized onto the chip. After capture hybridization for 90 minutes, the chips were washed with 1×SSC ten times on the system and scanned. The experiments were repeated by changing and recombining different tags for different samples.

A printed deconvolution table included the entire sequences for each of the different primers for the linear extension and made specific reference to the oligo-specific recognition sequence (in lower case in the table below) and test specific sequence (in upper case in the table below). The table made further reference to specific oligonucleotide ID (here: names for DPE primers, based on the oligo-specific recognition sequence), which was associated with a specific test sample number simulating a patient ID number. Finally, the table also included positional information with respect to expected binding of the respective labeled extension products. These results clearly indicated that test results for multiple and distinct samples can be identified for multiple and distinct patient samples based on signal location and associative data to yield specific results.

Primers for amplification of a target sequence in HPV were as follows (depicted as 5′ - - - 3′ sequence):

| PCR Primers | Sequence 5′ - - - 3′ | |
|---|---|---|
| Forward MY09 | CGTCCMARRGGAWACTGATC | SEQ ID 13 |
| Reverse MY11 | GCMCAGGGWCATAAYAATGG | SEQ ID 14 |

Primers for linear extension of the amplified sequences of HPV were as follows (depicted as 5′ - - - 3′ sequence):

| DPE Primers | Sequence 5′ - - - 3′ | |
|---|---|---|
| HPV16-LT8 | gctagatgaagagcaagcgcatggaACGCAGTACAAATATGTCAT | SEQ ID 15 |
| HPV16-LT9 | tacaaccgacagatgtatgtaaggcACGCAGTACAAATATGTCAT | SEQ ID 16 |
| HPV16-LT10 | ttcaatctggtctgacctccttgtgACGCAGTACAAATATGTCAT | SEQ ID 17 |
| HPV18-LT11 | acacgatgtgaatattatctgtggcTCGCAGTACCAATTTAACAA | SEQ ID 18 |
| HPV18-LT12 | ttgaagttcgcagaatcgtatgtgtTCGCAGTACCAATTTAACAA | SEQ ID 19 |
| HPV18-LT13 | aacgtctgttgagcacatcctgtaaTCGCAGTACCAATTTAACAA | SEQ ID 20 |

Primers for hybridization of extended and labeled sequences of HPV were as follows (depicted as 5′ - - - 3′ sequence; all biotinylated at 3′-end):

| Capture | | |
|---|---|---|
| Primers | Sequence 5′ - - - 3′Bio | |
| LT8 | tccatgcgcttgctcttcatctagc | SEQ ID 21 |
| LT9 | gccttacatacatctgtcggttgta | SEQ ID 22 |
| LT10 | cacaaggaggtcagaccagattgaa | SEQ ID 23 |
| LT11 | gccacagataatattcacatcgtgt | SEQ ID 24 |
| LT12 | acacatacgattctgcgaacttcaa | SEQ ID 25 |
| LT13 | ttacaggatgtgctcaacagacgtt | SEQ ID 26 |

Thus, specific embodiments and applications of compositions and methods related to anonymous deconvolution of combined patient samples have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of assisting execution of a multiplexed diagnostic assay, comprising:
providing a plurality of oligonucleotides, wherein
(a) a first population of the plurality of oligonucleotides have a common first portion that is specific for a first diagnostic marker;
(b) a second population of the plurality of oligonucleotides have a common first portion that is specific for a second diagnostic marker;
(c) wherein each of the plurality of oligonucleotides have a distinct second portion, and wherein each of the plurality of oligonucleotides has a unique identifier associated with the distinct second portion;
providing instructions to separately prepare a plurality of labeled nucleic acids from each of a plurality of different patient samples using at least one oligonucleotide of the first and second populations;
providing instructions to pool the pluralities of labeled nucleic acids from the different patient samples and to hybridize the pluralities of labeled nucleic acids to oligonucleotides immobilized to a solid phase; and
providing a deconvolution table that associates a single test result for each of the different patients based on the first and second diagnostic markers using the unique identifier.

2. The method of claim 1 wherein the solid phase comprises a chip in which the oligonucleotides are immobilized in a predetermined pattern.

3. The method of claim 1 wherein the solid phase comprises a plurality of color-coded beads, wherein beads of same color have same nucleotide sequences of the immobilized oligonucleotides.

4. The method of claim 1 wherein the first portions in the first and second populations have a length of between 12 and 40 nucleotides, respectively, and wherein the distinct second portions have a length of between 6 and 20 nucleotides.

5. The method of claim 1 wherein the unique identifier comprises at least one of a numerical sequence, alphanumerical sequence, and mixed numerical/alphanumerical sequence, and further includes a test reference.

6. The method of claim 1 wherein the step of preparing the plurality of labeled nucleic acids comprises a PCR reaction and a primer extension.

7. The method of claim 6 wherein the label in the plurality of labeled nucleic acids is a fluorophore.

8. The method of claim 1 wherein the first and second diagnostic markers are selected from the group consisting of a mutation in an oncogene, a mutation in a SNP, presence of a viral or bacterial nucleic acid, and a virotype.

9. The method of claim 1 wherein the deconvolution table comprises an electronic database and is provided as an on-line software upload or on a data carrier.

10. The method of claim 9 wherein the deconvolution table is configured to allow cooperation with a processor, a reader of an analytic device, and an output module of the analytic device such that the test result is calculated using a readout of the reader and such that the test result is provided to the output module.

11. The method of claim 10 wherein the step of providing the deconvolution table comprises providing the software of claim 13.

12. The method of claim 1 wherein the step of providing the deconvolution table comprises providing the software of claim 13.

13. A data storage medium comprising:
software programmed to establish a deconvolution table that includes
(a) associative data of a plurality of diagnostic marker-specific first portions of a plurality of oligonucleotides, respectively, with a plurality of distinct second portions present in each of the plurality of oligonucleotides;
(b) associative data of the distinct second portions of the plurality of oligonucleotides with a solid phase parameter; and
(c) associative data of each of the plurality of oligonucleotides with a patient identifier such that the table correlates a plurality of diagnostic tests for at least two distinct patients;
wherein the associative data (a) and (b) are preprogrammed; and
wherein the software is further programmed to acquire the patient identifier from at least one of an operator, an analytic device, and an electronic device coupled to the analytic device to thereby generate associative data (c).

14. The data storage medium of claim 13, wherein the software is further programmed to receive test results for each of the plurality of diagnostic tests to thereby establish a test result for the at least two distinct patients.

15. The data storage medium of claim 13, wherein the software is configured to allow cooperation with a reader of an analytic device and an output module of the analytic device such that a test result is calculated using a readout of the reader and such that the test result is provided to the output module.

16. The data storage medium of claim 13, wherein the plurality of diagnostic tests is performed by hybridization of the plurality of oligonucleotides to another plurality of oligonucleotides immobilized on a solid phase.

17. The data storage medium of claim 16, wherein the solid phase is comprises an oligonucleotide array chip.

18. The data storage medium of claim 17, wherein the solid phase parameter comprises location identification of at least one of the plurality of oligonucleotides on the array chip.

19. The data storage medium of claim 13 wherein the plurality of diagnostic marker-specific first portions are associated with a single condition.

20. The data storage medium of claim 13 wherein the single condition is selected from the group consisting of an infection, a neoplasm, and a genetic predisposition.
